(19) United States
(12) Patent Application Publication
(10) Pub. No.: US 2001/0007272 A1
(43) Pub. Date: Jul. 12, 2001

(54) Veneer edge jointing apparatus

(75) Inventor: Takao Minami, Yokohama-shi (JP)

Correspondence Address: Oliff & Berridge PLC, P.O. Box 19928, Alexandria, VA, 22320, US

(73) Assignee: MINAMI MACHINE CO., LTD.

(21) Appl. No.: 09/748,375

(22) Filed: Dec. 27, 2000

(30) Foreign Application Priority Data
Jan. 6, 2000 (JP) 2000-633

(51) Int. Cl. B29C 65/00; B31F 5/00; G03D 15/04

(52) U.S. Cl. 156/304.1; 156/502

(57) ABSTRACT

A veneer edge jointing apparatus which comprises a plurality of rows of conveyors (chains) for transporting a veneer piece until a trailing edge of the veneer piece in a direction of transportation comes to an abutting position; an adhesive-applying device for applying a hot melt adhesive to a leading edge of the transported veneer piece in the direction of transportation; and a bonding device for abutting the leading edge of the veneer piece transported by means of the conveyors against a trailing edge of a preceding veneer sheet in alignment with the abutting position, and then pushing and feeding the veneer piece to bond the veneer pieces to each other into a continuous veneer sheet. The bonding device is arranged at a position for substantially filling vacant regions in the direction of width orthogonal to the direction of transportation. The bonding device is provided with cooling panels comprising a lower cooling panel having a lower flat surface extending from upstream to downstream of the abutting position and an upper cooling panel having an upper flat surface. The veneer edge jointing apparatus can positively bond veneer pieces of poor quality, even lacking in strength or extremely wavy in shape, end to end with high quality.

### BACKGROUND OF THE INVENTION

1. Field of the Invention

The present invention relates to veneer edge jointing apparatuses. More particularly, it relates to a veneer edge jointing apparatus of a push-feed type which is preferably applied to bonding successive veneer pieces, lacking in strength or extremely wavy in shape, to form a continuous length of veneer.

2. Prior Art

Conventional veneer edge jointing apparatuses are disclosed, for example, in Japanese Patent Publications No.Hei 3-74161 or No.Hei 6-13162.

FIG. 5 is a schematic block diagram illustrating an example of conventional veneer edge jointing apparatuses. The veneer edge jointing apparatus 10 comprises upper and lower infeed conveyors 12 for loading veneer pieces of random sizes; a veneer detector 14 for detecting defective portions on veneer pieces of random sizes loaded by the infeed conveyors 12; a random clipper 16 comprising knives 16A and anvil 16B for cutting defective portions on the leading and trailing edges of successive veneer pieces of random sizes to form the usable veneer pieces in accordance with the information detected by the veneer detector 14; outfeed conveyors 20 having separator 18 swingable up and down at their upstream side for unloading the usable veneer pieces prepared by the random clipper 16; a bonding device 22 for applying adhesive on the leading edge of a usable veneer piece unloaded by the outfeed conveyors 20 to bond the veneer piece to the trailing edge of a preceding continuous veneer sheet; and a full size clipper 24 for cutting successive veneer pieces bonded in tandem with each other at the bonding device 22 into a full size veneer sheet A of a predetermined length. The veneer edge jointing apparatus is adapted to transport the full size veneer piece A, which has been cut by knives 24A and anvil 24B of the full size clipper 24, to an automatic stacking device 28 by a transport conveyor 26 to stack the veneer piece A at a predetermined position and thus stock it therein.

This veneer edge jointing apparatus is of the push-feed type which bonds the leading edge of a veneer piece with an adhesive applied thereon to the trailing edge of a preceding veneer sheet by a transverse pressure (bonding pressure) generated by the feed force of the succeeding veneer piece transported in the direction orthogonal to the direction of the grain thereof by the aforementioned outfeed conveyors 20, thus bonding veneer pieces to each other to form continuous veneer sheets. As the feature of the bonding device 22 viewed from above is shown in FIG. 6, the veneer edge jointing apparatus of this push-feed type guides a veneer piece C, forced to be transported on the upper conveyors 20A and the lower conveyors 20B of the outfeed conveyors 20, by sandwiching the veneer piece C between oppositely arranged several upper and lower rows of pressure bars 22A, 22B (four rows of pressure bars in this example). At the same time, the veneer edge jointing apparatus is adapted to produce resistance between the upper and lower pressure bars 22A, 22B and the veneer piece C to apply a transverse pressure to the veneer piece C against the feed force provided by the upper and lower upstream conveyors 20A, 20B. Considering the balance of the resistance to be applied to the veneer piece to produce the aforementioned transverse pressure, the upper and lower pressure bars 22A, 22B have a narrow width of approximately 5 to 10 mm and extend in the direction of the feed of the veneer piece, but are provided only partially in the direction of width of the veneer piece (in the direction of the grain thereof).

The afore-mentioned veneer edge jointing apparatus of the push-feed type had the following problems when veneer pieces were bonded edge to edge which were, for example, as thin as 1.8 mm or less and lacked in strength (a veneer piece of low strength).

An excessive weight of the upper pressure bars 22A which serve to press a veneer piece downwardly in said bonding device 22 would cause the weight to be applied to the veneer piece only partially because of the narrow width thereof. This will cause the surface pressure of the contact portions to be made higher between the pressure bars and the veneer piece, thereby leading to damage in the veneer piece in some cases and thus resulting in an excessive frictional resistance. Consequently, the veneer piece was given an unnecessarily high resistance to increase the feed resistance abnormally and thus cause the veneer piece to buckle. Thus, the buckling of the veneer piece would cause the pressure bars to be lifted and thus the veneer piece to be jammed, or result in an overlap between the edge-bonding surfaces of veneer pieces.

In contrast, an excessively small weight of the upper pressure bars 22A would press veneer pieces with a limited weight. This would cause a veneer piece to be curved upwardly between adjacent pressure bars due to an impact of push of a subsequent veneer piece. At this time, the pressure bars 22A would be lifted to cause a veneer piece, lacking in strength and transported in the direction orthogonal to the direction of the grain thereof, to buckle. In this case, veneer pieces would also be jammed or overlapped with each other. Therefore, the weight of the pressure bars is to be naturally restricted.

In order to avoid the foregoing situations, it is conceivable to increase the number of pressure bars. However, in this case, since the adhesive applied to the edges of a veneer piece protrudes more or less from the front and reverse sides thereof, the protruding adhesive will stick to the pressure bars. Since the adhesive adhered as such would act as a great resistance to the feeding of the veneer piece, the number of pressure bars is to be naturally limited. That is, since the adhesive adhered to the pressure bars causes the veneer piece to be jammed, it has to be avoided to apply the adhesive to the edge surface of the veneer piece to be in contact with the pressure bars. For this reason, an unreasonable increase in number of the pressure bars would decrease the area of the edge surface on which the adhesive is applied, resulting in a decrease in adhesive strength between veneer pieces. Accordingly, the critical portion on which the adhesive is applied and located between a pressure bar arranged at an area other than the installation region of the upper and lower conveyors 20A, 20B and another pressure bar adjacent to the pressure bar is not pressed neither from an upper nor a lower portion. This allows the veneer piece to be free to escape in that direction, causing a vertical discrepancy at the edge-bonding surfaces of veneer pieces and thus providing an insufficient bonding. Or, the veneer pieces tend to be easily curved upwardly and buckle at this portion.

Moreover, since a smaller amount of adhesive is applied to the edge-bonding surface of a thinner veneer piece due to the thin thickness thereof, it is very important to apply the adhesive on the possibly entire width of the veneer piece in order to obtain a positively edge-bonded veneer sheet of high quality. As described above, the veneer edge jointing apparatus of the conventional push-feed type could not be also said to provide a sufficient edge-bonding from the viewpoint of adhesive strength.

In particular, the preservation of natural forest has also been lately advocated from the pro-environmental viewpoint to place emphasis on producing plywood from planted logs. In addition, logs have been used at the same time which were once thought to be unsuitable for producing plywood therefrom. Many of veneer pieces formed from these logs are extremely wavy in shape (extremely irregular) but veneer pieces of good quality are required to be manufactured using these logs of poor quality. This provides severe requirements for the edge-bonding of core veneer pieces which are responsible for the quality of plywood. The extreme irregularity of even thin veneer pieces will also cause the adhesion of threads, tape, or the like to be defeated by the irregularity, thus making it difficult to edge bond veneer pieces to each other.

Suppose that the adjacent pressure bars 22A (22B) are spaced at large intervals. In this case, as veneer pieces of extreme irregularity are shown in an enlarged front view of FIG. 7 and in an enlarged perspective view of FIG. 8, the extreme irregularity of the veneer piece made it impossible to press the veneer piece C flat. In many cases, this caused the adhesive applied on edge bonding surfaces to be peeled off before cooled and set, thus making it impossible to provide a sufficient edge bonding.

### SUMMARY OF THE INVENTION

The present invention was developed to solve the aforementioned conventional problems, and an object of the present invention is to provide a veneer edge jointing apparatus of the push-feed type which assures high-quality edge-bonding by positively bonding the edge bonding surfaces of veneer pieces of even a poor quality such as those lacking in strength or extremely wavy in shape.

Disclosed herein is a veneer edge jointing apparatus comprising a plurality of rows of conveyors for transporting a veneer piece until a trailing edge of the veneer piece in a direction of transportation comes to an abutting position; a glue nozzle for applying a hot melt adhesive to a leading edge of the transported veneer piece in the direction of transportation; and a bonding device for abutting the leading edge of said veneer piece transported by means of said conveyors against a trailing edge of a preceding veneer piece in alignment with said abutting position, and then pushing and feeding the veneer piece to bond the veneer pieces to each other into a continuous veneer sheet. With this veneer edge jointing apparatus, the present invention solves the aforementioned problems by providing said bonding device which is arranged at a position for substantially filling vacant regions in the direction of width orthogonal to said direction of transportation, and comprises cooling panels having a lower flat surface extending from upstream to downstream of said abutting position to constitute veneer piece transportation planes and an upper flat surface arranged opposite to said lower flat surface to constitute a veneer piece pressure surfaces.

That is, according to the present invention, both the upper and lower flat surfaces of the cooling panels, arranged at a position for substantially filling vacant regions in the direction of width except for the regions for installing the conveyors from upstream to downstream of the abutting position and cooled down to a desired temperature at which sticking of the hot melt adhesive can be prevented, are adapted to sandwich veneer pieces being transported. Thus, without interfering with the feed of the veneer pieces due to the adhesive sticking to the both flat surfaces, it is possible to abut the leading edge of the succeeding veneer piece, on the generally entire edge surface of which the hot melt adhesive is applied, against the trailing edge of the preceding veneer sheet in alignment with the aforementioned abutting position, and then push and feed the veneer pieces to bond the veneer pieces to each other.

Accordingly, when the leading edge of the succeeding veneer piece is abutted to the trailing edge of the preceding veneer sheet and then the veneer pieces are pushed and fed, the conventional pressure bars could not be made heavier as described above, however, it is possible to make the cooling panels heavier, thereby making it possible to prevent the veneer pieces from being curved. Furthermore, even when the veneer pieces are pressed from above with a weight of a magnitude enough to exert a sufficient transverse pressure on the bonding surfaces, the weight can be distributed all over the flat surfaces since the veneer pieces are sandwiched by the flat surfaces of less resistance and a large area. That is, a partially concentrated weight can be avoided, thereby making it possible to positively bond veneer pieces, even lacking in strength, to each other with sufficient adhesion.

Furthermore, as described above, the veneer pieces can be pressed with the flat surfaces of a sufficient weight and a sufficient area at the abutting position. Thus, the veneer pieces can be positively prevented from being lifted due to a shock caused by a collision of the succeeding veneer piece, thereby making it possible to effectively prevent buckling and overlapping at the bonding edge surfaces. Furthermore, at the aforementioned abutting position, the spacing between the upper and lower flat surfaces is substantially restricted to the thickness of veneer pieces. Thus, a veneer piece extremely wavy in shape can also be made flat and then abutted to a preceding veneer sheet, thereby making it possible to achieve bonding of high quality.

Furthermore, as a sub-effect of use of the cooling panels, the hot melt adhesive can be expected to harden instantly, thereby preventing the adhesive from being peeled off at downstream transportation portions and making it possible to provide positive bonding.

As described above, the present invention makes it possible to assure high-quality edge-bonding by positively bonding the edge bonding surfaces of veneer pieces of a poor quality, even lacking in strength or extremely wavy in shape.

### BRIEF DESCRIPTION OF THE DRAWINGS

The above object, features and advantages of the present invention, as well as other objects and advantages thereof, will become more apparent from the description of the invention which follows, taken in conjunction with the accompanying drawings, wherein like reference characters designate the same or similar parts and wherein:

FIG. 1 is a side view illustrating the configuration of the main portion of a veneer edge jointing apparatus according to the present invention;

FIG. 2 is a side view illustrating the feature of cooling panels incorporated into a bonding device according to the embodiment of the present invention;

FIG. 3 is a plan view illustrating the feature of cooling panels incorporated into the bonding device according to the embodiment of the present invention;

FIG. 4 is an enlarged schematic front view illustrating the main portion of the cooling panel according to the embodiment of the present invention;

FIG. 5 is a side view illustrating the outline of the entire configuration of a conventional veneer edge jointing apparatus;

FIG. 6 is a plan view illustrating the feature of a conventional bonding device;

FIG. 7 is a front view of the main portion of the conventional bonding device, showing the problem thereof; and

FIG. 8 is a perspective view of the main portion of the conventional bonding device, showing the problem thereof.

### DESCRIPTION OF THE PREFERRED EMBODIMENTS

Preferred embodiments of the present invention will be explained hereunder.

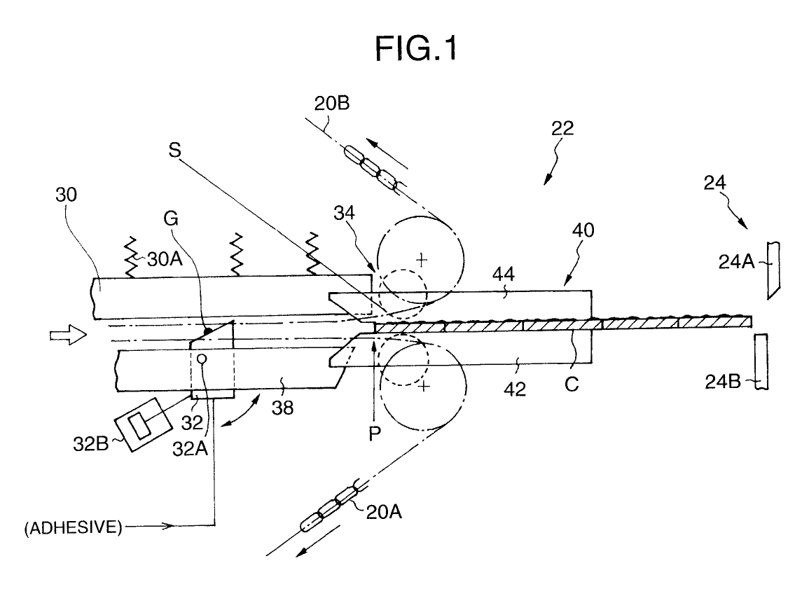

FIG. 1 is a schematic side view illustrating the configuration of the main portion of the bonding device incorporated into a veneer edge jointing apparatus according to the embodiment of the present invention.

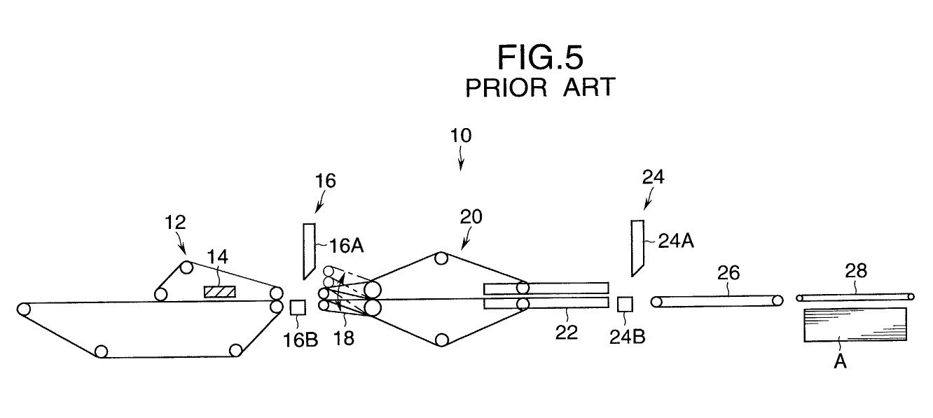

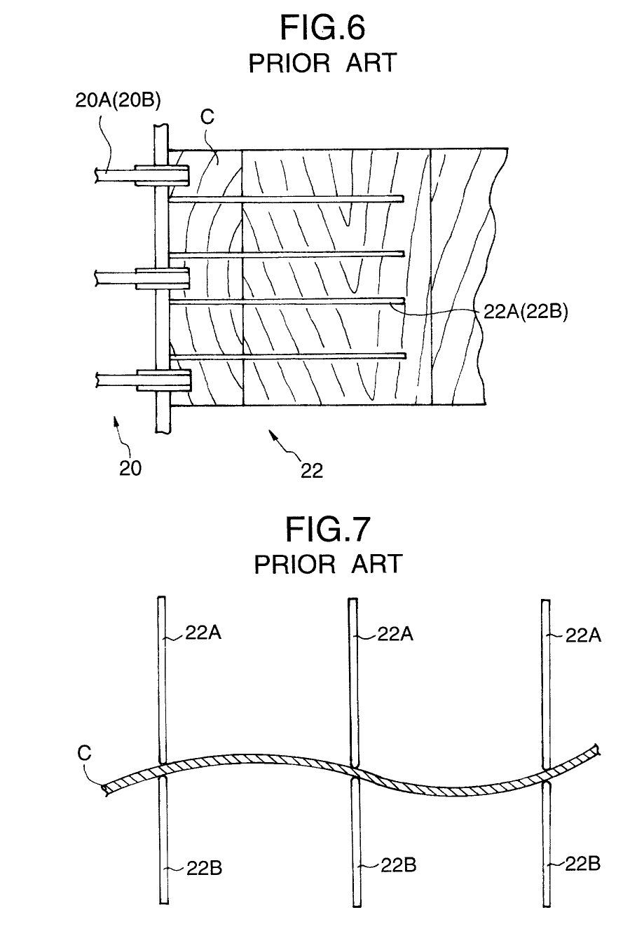

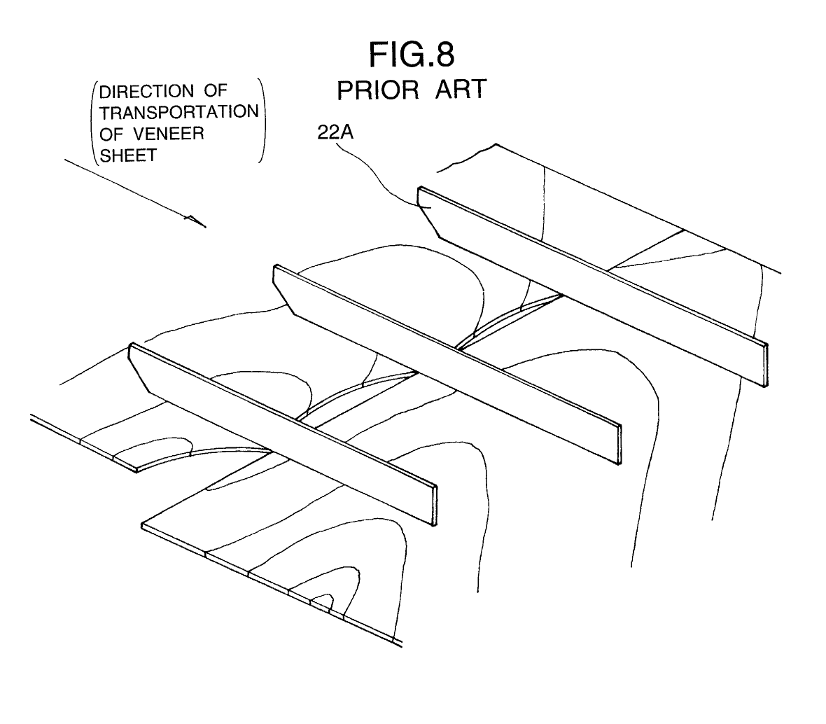

The veneer edge jointing apparatus according to this embodiment is substantially the same as the one illustrated in FIG. 5 except that the apparatus is provided with a bonding device, described below, as the bonding device designated by reference numeral 22 in FIG. 5. Accordingly, in the following explanations, the components substantially the same as those of the veneer edge jointing apparatus shown in FIG. 5 bear the same reference numerals and will not be described again.

The bonding device 22 incorporated into the veneer edge jointing apparatus according to this embodiment comprises a plurality of rows of lower chains (lower conveyors) 20A for supporting and transporting veneer pieces and the same number of upper chains (upper conveyors) 20B arranged opposite to each of the lower chains 20A. Here, the lower chains 20A and the upper chains 20B constitute the outfeed conveyors 20 shown in FIG. 5. Moreover, the bonding device 22 comprises pressure shoes 30 for pressing the upper chains 20B against a veneer piece C of a small width (a usable veneer piece) on the lower chains 20A to provide a feed force thereto and then transport the veneer piece C until the trailing edge thereof comes to an abutting position P where the feeding force ceases. The pressure shoes 30, not shown, are arranged in multiple rows corresponding to the aforementioned upper chains 20B such that the leading edges of the pressure shoes 30 in the direction of transportation are aligned substantially with a straight line orthogonal to that direction.

In addition, the aforementioned bonding device 22 is provided with an adhesive-applying device 32 which is arranged at a middle position of the pressure shoes 30 and between the outfeed conveyors 20 so as not to interfere therewith in order to apply an adhesive (a hot melt adhesive) G to the leading edge of successing veneer pieces. The bonding device 22 also comprises a thread-affixing device 34 which is also arranged at a position downstream from the pressure shoes 30 so as not to interfere with the chains of the outfeed conveyors 20 in order to affix connecting threads S on the upper surface of the continuous veneer sheet.

As a normal operation, the aforementioned bonding device 22 repeatedly transports veneer pieces by the pressure shoes 30 until the trailing edge of the veneer pieces is brought to the abutting position P at the push terminal end. As shown in FIG. 1, the trailing edge and the leading edge of preceding and succeeding veneer pieces C, respectively, are adapted to abut against each other at the aforementioned abutting position P. In addition, each of the abutted veneer pieces C is successively transported to the right to go through cooling panels 40 formed in a pair at an upper and a lower downstream portion and then firmly bonded to another by making use of the frictional resistance generated therein. Thereafter, the veneer pieces C are cut by the full size clipper 24 arranged downstream from the cooling panels 40 to form full size veneer sheet A.

Explaining the aforementioned bonding device in more detail, the aforementioned lower and upper chains 20A, 20B are adapted to rotate in the directions shown by the arrows, respectively, and move in the direction of transportation where they face to each other. The lower chains 20A are supported thereunder by means of a support block (rail) 38. In addition, the pressure shoes 30 are adapted to receive a pressing force provided by springs 30A and thereby always press the rear surface of the upper chains 20B, thereby providing a feed force to the veneer piece C. Therefore, when the pressing force provided by the pressure shoes 30 is used to transport the veneer piece C, the feed force will cease at the terminal end thereof. Thus, as illustrated, the veneer piece C is transported until the trailing edge thereof comes to the aforementioned abutting position P.

Furthermore, the aforementioned adhesive-applying device 32 is pivotable about a fulcrum 32A in the direction shown by the arrow. Thus, the adhesive-applying device 32 is adapted to be selectively moved to the position where the tip of a nozzle from which the adhesive G is dispensed is brought into contact with the leading edge of a veneer piece being transported or to the non-adhesive applying position (not shown) where the tip of the nozzle is placed under the plane of transportation. Accordingly, it is made possible to detect a veneer piece being transported at a predetermined position and apply adhesive to the leading edge of the veneer piece by a controller (not shown) in accordance with the detected signal.

Furthermore, the aforementioned thread-affixing device 34 presses the reinforcement threads, which are fed out of thread bobbins (not shown) and to which a hot melt adhesive is applied, against the veneer sheet C to affix the threads thereon by means of upper and lower thread-affixing rollers 34A, 34B.

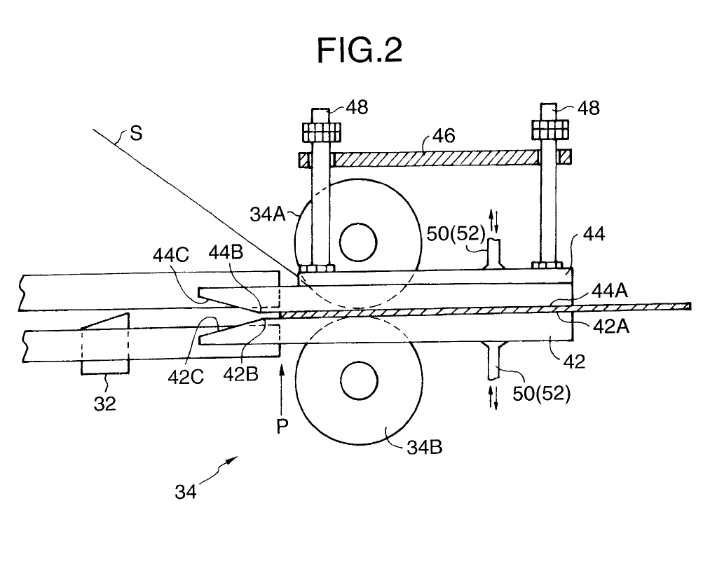

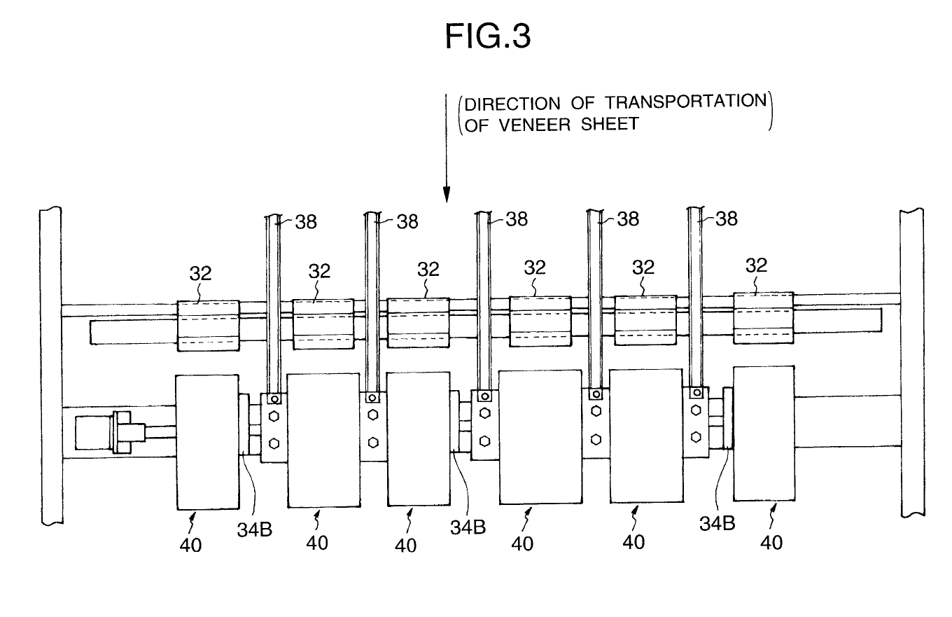

Furthermore, the aforementioned cooling panels 40 are formed in a pair of a lower cooling panel 42 and an upper cooling panel 44, as illustrated in FIG. 2 with the lower and upper chains 20A, 20B being not shown and in a top view of FIG. 3 to facilitate the understanding of the feature. In addition, the cooling panels 42, 44 are arranged so as not to interfere with the lower and upper chains 20A, 20B of the outfeed conveyors from the vicinity of the terminal end of the pressure shoes 30 to the vicinity downstream from the thread-affixing device 34. That is, the cooling panels 42, 44 are arranged to extend beyond the width of the veneer piece so as to substantially fill the vacant regions in the direction of width other than the regions of installation of the chains or the like. Moreover, the cooling panels 42, 44 are arranged so as to extend from upstream of the abutting position P to a position downstream therefrom. Accordingly, the aforementioned abutting position P is located inside the range of arrangement of the cooling panels 40.

On the upper portion of the upper cooling panel 44, there are vertically provided guide bars 48 to be slidably inserted into guide holes of frame members 46, thereby allowing the upper cooling panel 44 to be freely movable up and down. Furthermore, the upper surface of the aforementioned lower cooling panel 42 or a lower flat surface 42A is aligned with the feed surface of the veneer piece (substantially constituting the feed surface of the veneer piece). The spacing between the lower flat surface 42A and an upper flat surface 44A or the lower surface of the upper cooling panel 44 can be varied according to the thickness of the veneer piece to be transported. In addition, the spacing between the lower flat surface 42A and the upper flat surface 44A can be varied to allow the transverse pressure to be adjusted by varying the pressure from above with the own weight, the springs or the like. When a veneer piece is allowed to go between the both flat surfaces, a transverse pressure generated by the frictional resistance caused by the own weight of the upper cooling panel 44 is acted upon between preceding and succeeding veneer pieces, thereby making it possible to firmly bond the veneer pieces to each other.

Furthermore, a cooling medium supplied from pipes 50 and discharged from pipes 52 is circulated inside the upper and lower cooling panels 42, 44 to cool the cooling panels down to a desired temperature, thereby preventing the hot melt adhesive from sticking to the aforementioned flat surfaces 42A, 44A. The cooling temperature depends on the type and hardening temperature of the hot melt adhesive to be used but have to be those at which the adhesive hardens instantly so as not to stick to the surface of the cooling panels 42, 44. To meet these requirements, the temperature can be normally 15° C. or less and preferably within the range from −5 to 10° C., and an antifreeze fluid such as an ethylene glycol solution can be used as the cooling medium. Furthermore, the cooling panels 40 are made of a material of good heat conductivity such as aluminum or stainless steel. Surface treatment such as plating, coating with Teflon (a trademark of Du Pont), or applying silicon oil as a release agent may be performed on the both upper and lower flat surfaces 42A, 44A to be brought into contact with the veneer piece C to improve durability and smoothness thereof.

Furthermore, the cooling panels 40 are provided with guideways 42C, 44C each continuously formed on each of the upstream edges 42B, 44B of the upper and lower flat surfaces 42A, 44A. The guideways 42C, 44C are formed of inclined surfaces, the spacing between which gradually increases toward upstream. Accordingly, the leading edge of an extremely wavy veneer piece can also be guided into and passed through between both the flat surfaces 42A, 44A readily and positively.

In this embodiment described above, veneer pieces can be manufactured successively in the following manner. That is, the adhesive-applying device 32 first applies a hot melt adhesive to the leading edge of a succeeding veneer piece forcedly fed by the lower and upper chains 20A, 20B. Then, the veneer piece is allowed to go through between the upper and lower flat surfaces 42A, 44A of the cooling panels 40 to be abutted against the trailing edge of a preceding veneer piece held at the abutting position P downstream from the upstream edges 42B, 44B of the both flat surfaces. Then, the succeding veneer piece is pushed to be fed until the trailing edge thereof comes to the abutting position P.

In this embodiment, the cooling panels 40 are cooled down to the aforementioned temperature to prevent the hot melt adhesive from sticking to the both flat surfaces 42A, 44A. Therefore, substantially no restrictions are imposed on the area of the edge surfaces to which the adhesive can be applied. Thus, the cooling panels 40 can be installed on the entire vacant region in the direction of width except for the region of installation of the lower and upper chains 20A, 20B or the like.

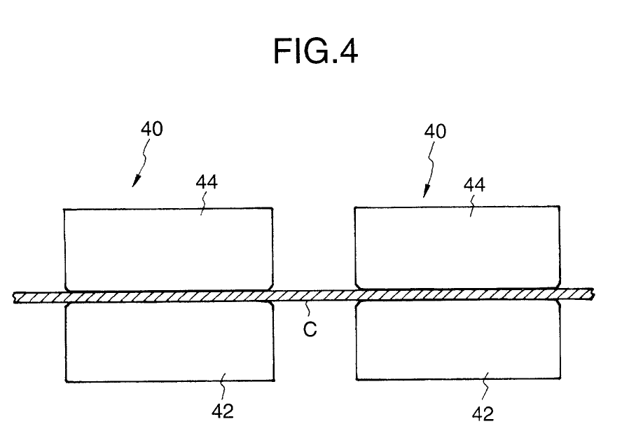

As part of the front view corresponding to FIG. 7 is shown in FIG. 4, this allows the veneer piece C to be held in a flat shape. Even when the entire weight of the upper cooling panel 44 is increased to prevent the veneer piece from being curved, the weight can be distributed all over the veneer piece, thereby making it possible to prevent excessive transportation resistance caused by partially concentrated weight. Thus, troubles such as buckling, jamming, or overlapping of veneer pieces can be effectively prevented, so that veneer pieces thin in thickness and lacking in strength can be edge bonded with high quality.

Moreover, since adhesive can be applied to most part of the width of the leading edge of a veneer piece, a thin veneer piece to the edge surface of which only a small amount of adhesive is applied can be positively bonded to another veneer piece. Furthermore, the cooling panels 40 can correct the irregularity of veneer pieces extremely wavy in shape and of many irregularities by applying an adhesive to the most part of the leading edge of the width of the veneer pieces. In addition, the adhesive can be solidified faster than by natural cooling, thereby making it possible to bond positively the veneer pieces to each other.

Accordingly, veneer pieces as thin as 1.8 mm or less and lacking in strength can be edge bonded to each other without causing buckling, jamming or the like. Moreover, veneer pieces extremely wavy in shape can also be positively edge bonded to each other. Thus, the occurrence of interruption of the process or the like caused by the aforementioned troubles can be prevented, thereby making it possible to drastically improve the productivity and the quality of the products.

The present invention has been described specifically in the foregoing, however, the present invention is not limited to the aforementioned embodiment but various changes and modifications may be made in the present invention without departing from the spirit and scope thereof.

For example, in the aforementioned embodiment, such an example has been shown in which the upper cooling panel 44 presses the veneer piece by its own weight. However, the weight may be made variable using fluid cylinders, springs or the like. Furthermore, the specific shape or material or the like of the aforementioned cooling panels 40 is not limited to those described in the aforementioned embodiment. For example, the aforementioned guideways 42C, 44C are not limited to linearly inclined surfaces but may be formed of circular arc surfaces.

Furthermore, to cool the aforementioned cooling panels 42, 44 down to a desired temperature, the cooling panels may be formed of a thermoelectric refrigerating device comprising thermoelectric elements.

What is claimed is:

1. A veneer edge jointing apparatus comprising
a plurality of rows of conveyors for transporting a veneer piece until a trailing edge of the veneer piece in a direction of transportation comes to an abutting position,
an adhesive-applying device for applying a hot melt adhesive to a leading edge of the transported veneer piece in the direction of transportation, and
a bonding device for abutting the leading edge of said veneer piece transported by means of said conveyors against a trailing edge of a preceding veneer piece in alignment with said abutting position, and then pushing and feeding the veneer piece to bond the veneer pieces to each other into a continuous veneer piece, wherein
said bonding device is arranged at a position for substantially filling vacant regions in the direction of width orthogonal to said direction of transportation, and comprises cooling panels having a lower flat surface extending from upstream to downstream of said abutting position to constitute veneer piece transportation planes and an upper flat surface arranged opposite to said lower flat surface to constitute a veneer piece pressure surfaces.

2. The veneer edge jointing apparatus according to claim 1, wherein said cooling panels are arranged over a region beyond a width of the veneer piece.

3. The veneer edge jointing apparatus according to claim 1, wherein a spacing between said lower flat surface and upper flat surface can be varied according to a thickness of the veneer piece to be worked.

4. The veneer edge jointing apparatus according to claim 1, wherein
when veneer pieces are allowed to go into between said lower and upper flat surfaces, said both flat surfaces can apply a necessary transverse pressure to between preceding and succeeding veneer pieces.

5. The veneer edge jointing apparatus according to claim 1, wherein
said cooling panels are forcibly cooled down to a predetermined temperature or less by circulating a cooling medium therein.

6. The veneer edge jointing apparatus according to claim 5, wherein
said predetermined temperature allows said hot melt adhesive to harden instantly so as not to stick to surfaces of the cooling panels.

7. The veneer edge jointing apparatus according to claim 6, wherein said predetermined temperature is within a range from −5 to 10° C.

8. The veneer edge jointing apparatus according to claim 5, wherein said cooling medium is an antifreeze fluid.

9. The veneer edge jointing apparatus according to claim 1, wherein
surface treatment is performed on said lower and upper flat surfaces to improve durability and smoothness thereof.

10. The veneer edge jointing apparatus according to claim 1, wherein
at upstream edges of said lower and upper flat surfaces, successively formed are guideways comprising inclined surfaces having a spacing between both the flat surfaces gradually increased toward upstream for guiding veneer pieces and for allowing the veneer pieces to go into between both the flat surfaces.
